(19) United States
(12) Patent Application Publication
(10) Pub. No.: US 2025/0392089 A1
(43) Pub. Date: Dec. 25, 2025

(54) BUS BAR AND POWER SUPPLY DEVICE

(71) Applicant: TDK CORPORATION, Tokyo (JP)

(72) Inventors: Masanobu TABUCHI, Tokyo (JP); Kenji NEGORO, Tokyo (JP)

(73) Assignee: TDK CORPORATION, Tokyo (JP)

(21) Appl. No.: 19/240,833

(22) Filed: Jun. 17, 2025

(30) Foreign Application Priority Data
Jun. 20, 2024 (JP) 2024-099591

(51) Int. Cl. H01R 25/16; H02M 3/00

(52) U.S. Cl. CPC H01R 25/161; H02M 3/003

(57) ABSTRACT

A bus bar is a bus bar electrically connecting a substrate housed in a housing and an output terminal, and includes: a main body portion extending in a predetermined direction; a substrate connection portion connected to the substrate on one end side of the main body portion; an output terminal connection portion connected to the output terminal on another end side of the main body; a first capacitor connection portion connected to a first capacitor mounted on the substrate; a first path portion electrically connecting the output terminal connection portion and the first capacitor connection portion and including a part of the main body portion; a second capacitor connection portion connected to a second capacitor mounted on the substrate; and a second path portion electrically connecting the output terminal connection portion and the second capacitor connection portion, the second path portion branching off from the first path portion.

### CROSS-REFERENCE TO RELATED APPLICATIONS

This application is based upon and claims the benefit of priority from Japanese Patent Application No. 2024-099591, filed on Jun. 20, 2024, the entire contents of which are incorporated herein by reference.

### TECHNICAL FIELD

The present disclosure relates to a bus bar and a power supply device.

### BACKGROUND

Conventionally, a power supply device having an output terminal is known (Japanese Unexamined Patent Publication No. 2015-57806). In this power supply device, noise is reduced by causing a ferrite core to penetrate an output terminal.

### SUMMARY

In the power supply device described above, a bus bar may be used to supply power from a substrate inside a housing to the output terminal. Here, the bus bar may be provided with a capacitor connection portion for connecting a capacitor of the substrate at a middle position of the bus bar in order to release the noise. However, since the bus bar is a long member, the noise may be picked up between the capacitor connection portion and the output terminal. In addition, for example, in a case where a measure, such as combining the bus bar, the ferrite core, and the capacitor to form one noise canceling component, is taken, an additional process such as component assembly or resin molding is required. Therefore, it has been required to reduce noise while suppressing cost and man-hours.

An object of the present disclosure is to provide a bus bar and a power supply device that reduce noise while suppressing cost and man-hours.

A bus bar according to an aspect of the present disclosure is a bus bar electrically connecting a substrate housed in a housing and an output terminal, and includes: a main body portion extending in a predetermined direction; a substrate connection portion connected to the substrate on one end side of the main body portion; an output terminal connection portion connected to the output terminal on another end side of the main body portion; a first capacitor connection portion connected to a first capacitor mounted on the substrate; a first path portion electrically connecting the output terminal connection portion and the first capacitor connection portion and including a part of the main body portion; a second capacitor connection portion connected to a second capacitor mounted on the substrate; and a second path portion electrically connecting the output terminal connection portion and the second capacitor connection portion, the second path portion branching off from the first path portion.

The bus bar according to the aspect of the present disclosure includes the substrate connection portion connected to the substrate on one end side of the main body portion, and the output terminal connection portion connected to the output terminal on the other end side of the main body portion. Therefore, an output current received from the substrate by the substrate connection portion is supplied to the output terminal connection portion via the main body portion. The bus bar includes the first capacitor connection portion connected to the first capacitor mounted on the substrate, and the first path portion electrically connecting the output terminal connection portion and the first capacitor connection portion and including a part of the main body portion. Therefore, noise superimposed on a current flowing through the main body portion is released to the substrate side by the first capacitor connection portion. Further, the bus bar includes the second capacitor connection portion connected to the second capacitor mounted on the substrate, and the second path portion electrically connecting the output terminal connection portion and the second capacitor connection portion. Such a second path portion branches off from the first path portion. Therefore, even in a case where the output current picks up noise between the first capacitor connection portion and the output terminal connection portion, the noise can be released to the substrate side by the second capacitor connection portion via the second path portion branching off from the first path portion. As described above, it is possible to reduce noise while suppressing cost and man-hours.

The second path portion may branch from the first path portion at the output terminal connection portion. In this case, it is possible to suppress noise from being added to the output current between the branch portion of the first path portion and the second path portion, and the output terminal connection portion.

The second path portion may be provided at a position closer to the output terminal connection portion than the first path portion. In this case, it is possible to suppress noise from being applied to the output current in the second path portion.

Each of the first path portion and the second path portion may include a portion facing the side surface of the housing. With this arrangement, the noise in the output current can be reduced due to the influence of the side surface of the housing.

A power supply device according to an aspect of the present disclosure may include the above-described bus bar. As a result, it is possible to release noise generated from the power supply device and reduce noise by using the above-described bus bar in the power supply device.

The number of the second capacitors connected to the second capacitor connection portion may be smaller than the number of the first capacitors connected to the first capacitor connection portion. As a result, a frequency band of noise that can be canceled by the first capacitor connection portion and the second capacitor connection portion increases, and the noise can be more effectively canceled.

According to the present disclosure, it is possible to provide the bus bar and the power supply device that reduce noise while suppressing cost and man-hours.

### BRIEF DESCRIPTION OF THE DRAWINGS

FIG. 1 is a side view illustrating a power supply device including a connection structure according to an embodiment of the present disclosure;

FIG. 2 is a perspective view of the connection structure;

FIG. 3 is a perspective view of a bus bar according to the present embodiment;

FIG. 4 is a perspective view of the bus bar according to the present embodiment;

FIG. 5 is a circuit diagram of the power supply device;

FIG. 6 is a perspective view of a bus bar according to a comparative example;

FIG. 7 is a circuit diagram of a power supply device according to a comparative example; and

FIGS. 8A and 8B are graphs illustrating comparison of noise between the bus bars according to the embodiment and the comparative example.

### DETAILED DESCRIPTION

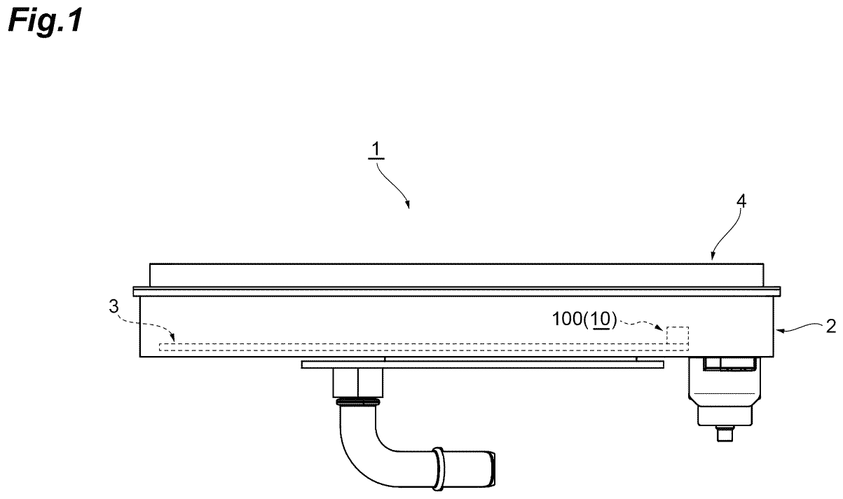

A power supply device 1 that includes a connection structure 100 including a bus bar 10 according to an embodiment of the present disclosure will be described with reference to FIG. 1. FIG. 1 is a side view illustrating the power supply device 1 including the connection structure 100 according to the embodiment of the present disclosure. As illustrated in FIG. 1, the power supply device 1 includes a base plate 2 (housing), a substrate 3, and a lid body 4. The power supply device 1 is configured by assembling the lid body 4 and the base plate 2 in the state of housing the substrate 3. As a material of the base plate 2, a die casting alloy or the like is applied. The power supply device 1 is a unit including, for example, an AC/DC power supply, a DC/DC converter, and the like. The connection structure 100 is provided in the power supply device 1. However, the overall shape of the power supply device 1 is not limited to that illustrated in FIG. 1. In addition, a position of the connection structure 100 in the power supply device 1 is also not particularly limited.

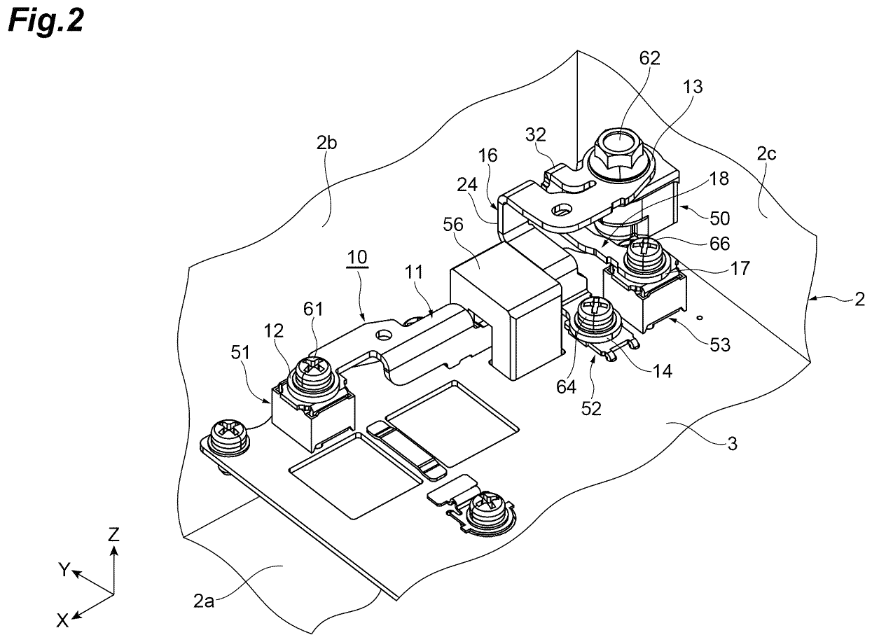

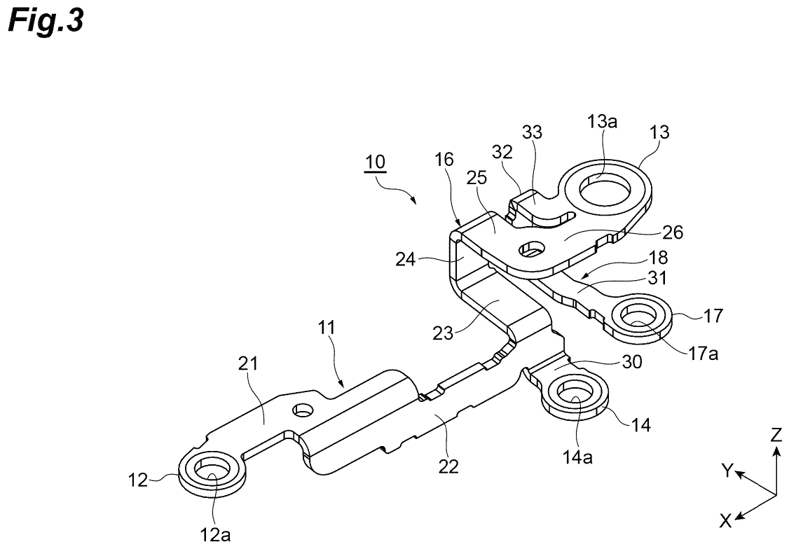

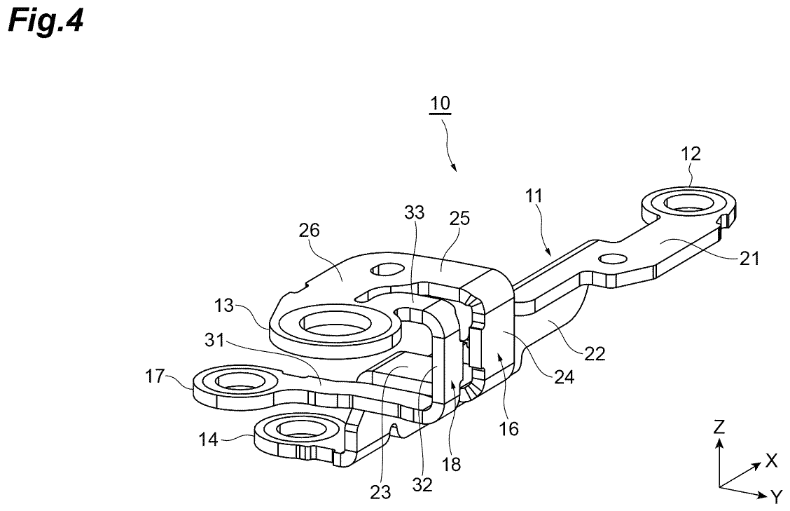

The connection structure 100 including the bus bar 10 according to the embodiment of the present disclosure will be described with reference to FIGS. 2 to 4. FIG. 2 is a perspective view of the connection structure 100. FIGS. 3 and 4 are perspective views of the bus bar 10 according to the present embodiment. Note that an X-axis direction and a Y-axis direction are set to illustrate directions in which a bottom surface 2a of the base plate 2 and the substrate 3 (see FIG. 1) extend. In addition, a Z-axis direction is set to illustrate a thickness direction of the bottom surface 2a of the base plate 2 and the substrate 3. In the present specification, the upper side is defined as a positive side in the Z-axis direction, and the lower side is defined as a negative side in the Z-axis direction. Although terms such as “upper” and “lower” may be used for convenience of description in the present specification, these do not limit a posture of the power supply device 1 or the connection structure 100 during use. As illustrated in FIG. 2, the connection structure 100 includes the base plate 2, the substrate 3, and the bus bar 10.

The base plate 2 has the bottom surface 2a extending parallel to an XY plane and side surfaces 2b and 2c erected from edges of the bottom surface 2a. The side surface 2b extends substantially parallel to an XZ plane. The side surface 2c extends substantially parallel to a YZ plane. In the present embodiment, the bus bar 10 is arranged near a corner of the base plate 2 where the bottom surface 2a and the side surfaces 2b and 2c are connected to each other. The side surface 2c is provided with an output terminal 50. The output terminal 50 is a terminal that outputs DC power from the power supply device 1 to an external device.

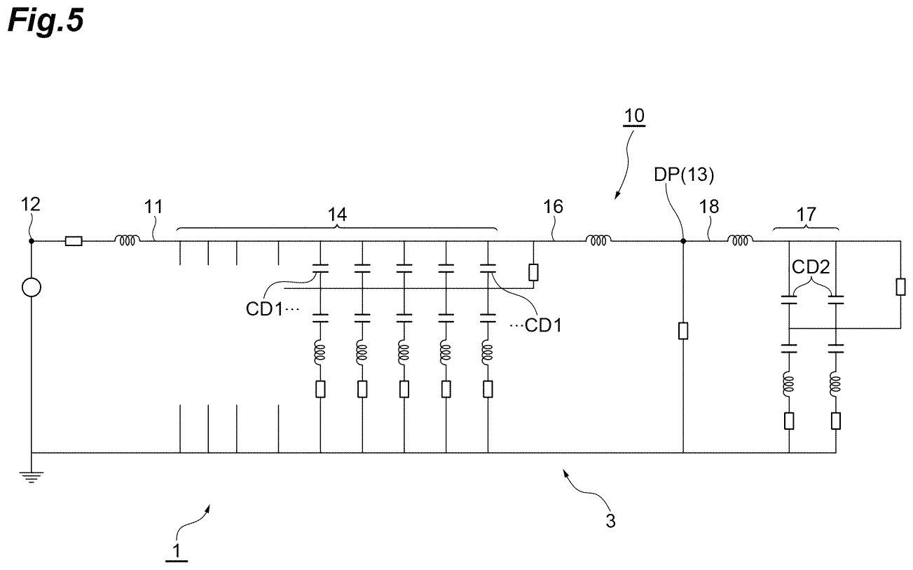

The substrate 3 is a plate-shaped member housed in the base plate 2. The substrate 3 extends substantially parallel to the XY plane at a position separated upward from the bottom surface 2a. The substrate 3 is provided with various terminals for connection with the bus bar 10. Specifically, the substrate 3 includes a terminal 51, a first capacitor terminal 52, and a second capacitor terminal 53. The terminal 51 is arranged at a position separated from the terminal 50 of the base plate 2 toward the positive side in the X-axis direction. The terminal 51 is a terminal that supplies DC power from the substrate 3 to the bus bar 10. The capacitor terminals 52 and 53 are arranged at positions closer to the output terminal 50 between the output terminal 50 and the terminal 51 in the X-axis direction. The first capacitor terminal 52 is arranged at a position adjacent to the second capacitor terminal 53 on the positive side in the X-axis direction. However, the arrangement of the terminals 51, 52, and 53 illustrated in FIG. 2 is merely an example, and may be appropriately changed. The first capacitor terminal 52 is connected to a first capacitor (see FIG. 5) mounted on the substrate 3. The second capacitor terminal 53 is connected to a second capacitor mounted on the substrate 3. The capacitor terminals 52 and 53 are terminals for releasing noise of the bus bar 10 to the substrate 3 by connecting the capacitors of the substrate 3 to the bus bar 10.

The bus bar 10 is a conductive member that electrically connects the substrate 3 and the output terminal 50. Although a material of the bus bar 10 is not particularly limited, copper, aluminum, or the like may be adopted. The bus bar 10 includes a main body portion 11, a substrate connection portion 12, an output terminal connection portion 13, a first capacitor connection portion 14, a first path portion 16, a second capacitor connection portion 17, and a second path portion 18. In the present embodiment, the bus bar 10 is a member in which these constituent elements 11, 12, 13, 14, 16, 17, and 18 are integrally formed by cutting and bending one sheet metal. Therefore, the bus bar 10 is configured as one sheet metal member. However, the bus bar 10 is not necessarily formed only by bending one sheet metal, and may be formed by joining a plurality of sheet metals by a joining method such as welding.

As illustrated in FIGS. 2 to 4, the main body portion 11 extends in the X-axis direction as a whole. The main body portion 11 electrically connects the terminal 51 of the substrate 3 and the output terminal 50 of the side surface 2c of the base plate 2. In the present embodiment, an end of the main body portion 11 on the positive side in the X-axis direction is arranged near the terminal 51, and an end of the main body portion 11 on the negative side in the X-axis direction is arranged near the output terminal 50. As illustrated in FIGS. 3 and 4, the main body portion 11 includes a first portion 21, a second portion 22, a third portion 23, a fourth portion 24, a fifth portion 25, and a sixth portion 26 in this order from the end on the positive side to the end on the negative side in the X-axis direction.

The first portion 21 extends toward the negative side in the X-axis direction in the state of extending parallel to the XY plane. The second portion 22 extends from an end of the first portion 21 on the negative side in the X-axis direction to the negative side in the X-axis direction in the state of extending parallel to the XZ plane. The second portion 22 is connected to an edge of the first portion 21 on the negative side in the Y-axis direction. The third portion 23 extends from an end of the second portion 22 on the negative side in the X-axis direction to the positive side in the Y-axis direction in the state of extending parallel to the XY plane. The third portion 23 is connected to an upper edge of the second portion 22. The fourth portion 24 extends from an end of the third portion 23 on the positive side in the Y-axis direction to the upper side in the state of expanding parallel to the XZ plane. The fifth portion 25 extends from an upper end of the fourth portion 24 to the negative side in the Y-axis direction in the state of extending parallel to the XY plane. The sixth portion 26 extends from an end of the fifth portion 25 on the negative side in the Y-axis direction to the negative side in the X-axis direction in the state of extending parallel to the XY plane. An end of the sixth portion 26 on the negative side in the X-axis direction is connected to the output terminal connection portion 13. Note that an electronic component 56 is provided between the first portion 21 and the third portion 23 in the second portion 22 so as to straddle the second portion 22 (see FIG. 2).

As illustrated in FIG. 2, the substrate connection portion 12 is a portion connected to the substrate 3 on one end side of the main body portion 11 on the positive side in the X-axis direction. The substrate connection portion 12 is connected to the substrate 3 via the terminal 51. The substrate connection portion 12 is fixed to the terminal 51 using a bolt 61 inserted into a through-hole 12a (see FIG. 3) from the upper side to the lower side and fastened to the terminal 51. As a result, the bus bar 10 is electrically connected to the terminal 51 via the substrate connection portion 12.

The output terminal connection portion 13 is a portion connected to the output terminal 50 on the other end side of the main body portion 11 in the X-axis direction. The output terminal connection portion 13 is fixed to the output terminal 50 using a bolt 62 inserted into a through-hole 13a (see FIG. 3) from the upper side to the lower side and fastened to the output terminal 50. As a result, the bus bar 10 is electrically connected to the terminal 51 via the output terminal connection portion 13.

The first capacitor connection portion 14 is a portion connected to the first capacitor between the terminal 51 and the output terminal 50 in the X-axis direction. The first capacitor connection portion 14 is fixed to the first capacitor terminal 52 using a bolt 64 inserted into a through-hole 14a (see FIG. 3) from the upper side to the lower side and fastened to the first capacitor terminal 52. Note that an upper surface of the first capacitor terminal 52 is located lower than upper surfaces of the other terminals 50, 51, and 53. Therefore, the first capacitor connection portion 14 is located lower than the other connection portions 12, 13, and 17.

The first path portion 16 is a portion that electrically connects the output terminal connection portion 13 and the first capacitor connection portion 14, and includes a part of the main body portion 11. As illustrated in FIG. 3, the first path portion 16 includes a part of the main body portion 11 and a coupling portion 30 in the present embodiment. The coupling portion 30 is a portion that couples the first capacitor connection portion 14 and the main body portion 11. The first path portion 16 includes, as a part of the main body portion 11, the second portion 22 (end on the negative side in the X-axis direction), the third portion 23, the fourth portion 24, the fifth portion 25, and the sixth portion 26. The coupling portion 30 extends from a lower end of the second portion 22 to the negative side in the Y-axis direction, and is connected to the first capacitor connection portion 14 at an end on the negative side in the Y-axis direction. As a result, the bus bar 10 is electrically connected to the first capacitor terminal 52 and the first capacitor via the first capacitor connection portion 14 and the first path portion 16.

The second capacitor connection portion 17 is a portion connected to the second capacitor between the terminal 51 and the output terminal 50 in the X-axis direction. The second capacitor connection portion 17 is fixed to the second capacitor terminal 53 using a bolt 66 inserted into a through-hole 17a (see FIG. 3) from the upper side to the lower side and fastened to the second capacitor terminal 53.

The second path portion 18 electrically connects the output terminal connection portion 13 and the second capacitor connection portion 17. The second path portion 18 branches off from the first path portion 16. In the present embodiment, the second path portion 18 branches off from the first path portion 16 at the output terminal connection portion 13. In addition, the second path portion 18 is provided at a position closer to the output terminal connection portion 13 than the first path portion 16. The second path portion 18 is arranged on the negative side in the X-axis direction with respect to the first path portion 16.

Specifically, the second path portion 18 includes a first coupling portion 31, a second coupling portion 32, and a third coupling portion 33. The first coupling portion 31 extends from the second capacitor connection portion 17 to the positive side in the Y-axis direction in the state of extending parallel to the XY plane. The second coupling portion 32 extends from an end of the first coupling portion 31 on the positive side in the Y-axis direction to the upper side in the state of extending parallel to the XZ plane. The third coupling portion 33 extends from an upper end of the second coupling portion 32 to the negative side in the Y-axis direction in the state of extending parallel to the XY plane. An end of the third coupling portion 33 on the negative side in the Y-axis direction is connected to the output terminal connection portion 13 at an edge on the negative side in the X-axis direction. As a result, the bus bar 10 is electrically connected to the second capacitor terminal 53 and the second capacitor via the second capacitor connection portion 17 and the second path portion 18.

A part of the first coupling portion 31 on the positive side in the Y-axis direction is provided adjacent to the third portion 23 at a position separated from the third portion 23 on the negative side in the X-axis direction. The second coupling portion 32 is arranged adjacent to the fourth portion 24 at a position separated from the fourth portion 24 on the negative side in the X-axis direction. The third coupling portion 33 is arranged adjacent to the fifth portion 25 at a position separated from the fifth portion 25 on the negative side in the X-axis direction.

The first path portion 16 and the second path portion 18 include portions facing the side surface 2b of the base plate 2. Specifically, the fourth portion 24 of the first path portion 16 and the second coupling portion 32 of the first path portion 16 extend in parallel to the XZ plane at positions close to the side surface 2b. Therefore, the fourth portion 24 and the second coupling portion 32 extend substantially parallel to the side surface 2b.

Next, a circuit configuration of the power supply device 1 will be described with reference to FIG. 5. The circuit configuration illustrated in FIG. 5 includes the bus bar 1 and a part of the substrate 3. In the substantially rectangular circuit configuration, a portion corresponding to the upper side corresponds to the bus bar 1. The bus bar 1 branches into the first path portion 16 and the second path portion 18 at a branch point DP. A plurality of first capacitors CD1 are connected on the first path portion 16 side. Here, five first capacitors CD1 are connected. Although a total of nine first capacitors CD1 can be connected to the first capacitor connection portion 14, the five first capacitors CD1 are provided since there is no difference in performance when five or more first capacitors CD1 are provided. A plurality of second capacitors CD2 are connected on the second path portion 18 side. Here, two first capacitors CD1 are connected. The capacitors CD1 and CD2 are provided on the substrate 3. As described above, the number of the second capacitors CD2 connected to the second capacitor connection portion 17 is smaller than the number of the first capacitors CD1 connected to the first capacitor connection portion 14. As a result, most of the noise of the bus bar 10 can be canceled by the first capacitor connection portion 14, and the remaining small noise can be canceled by the second capacitor connection portion 17. Note that a resistance component and an inductor component are formed in each portion of the bus bar 1 due to provision of a conductor portion of a predetermined length.

Next, functions and effects of the connection structure 100 according to the present embodiment will be described.

The bus bar 10 according to the present embodiment includes the substrate connection portion 12 connected to the substrate 3 on one end side of the main body portion 11, and the output terminal connection portion 13 connected to the output terminal 50 on the other end side of the main body portion 11. Therefore, an output current received by the substrate connection portion 12 from the substrate 3 is supplied to the output terminal connection portion 13 via the main body portion 11. The bus bar 10 includes the first capacitor connection portion 14 connected to the first capacitors CD1 mounted on the substrate 3, and the first path portion 16 that electrically connects the output terminal connection portion 13 and the first capacitor connection portion 14 and includes a part of the main body portion 11. Therefore, noise superimposed on a current flowing through the main body portion 11 is released to the substrate 3 side by the first capacitor connection portion 14.

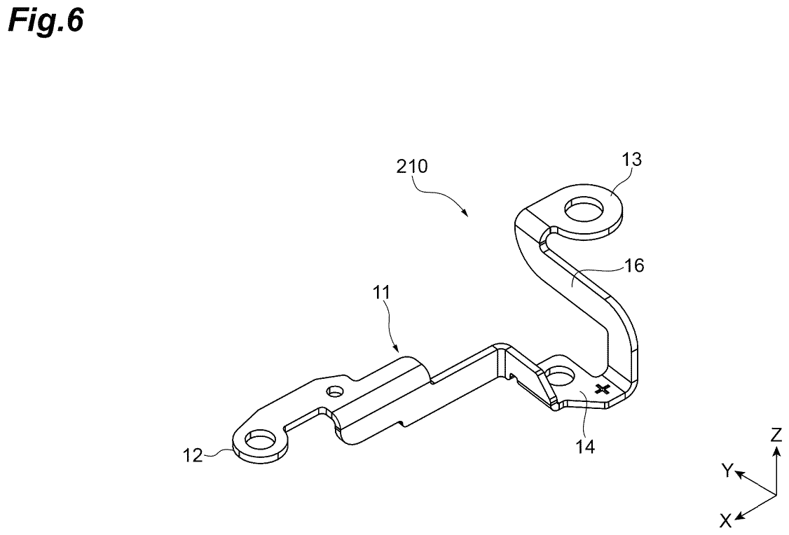

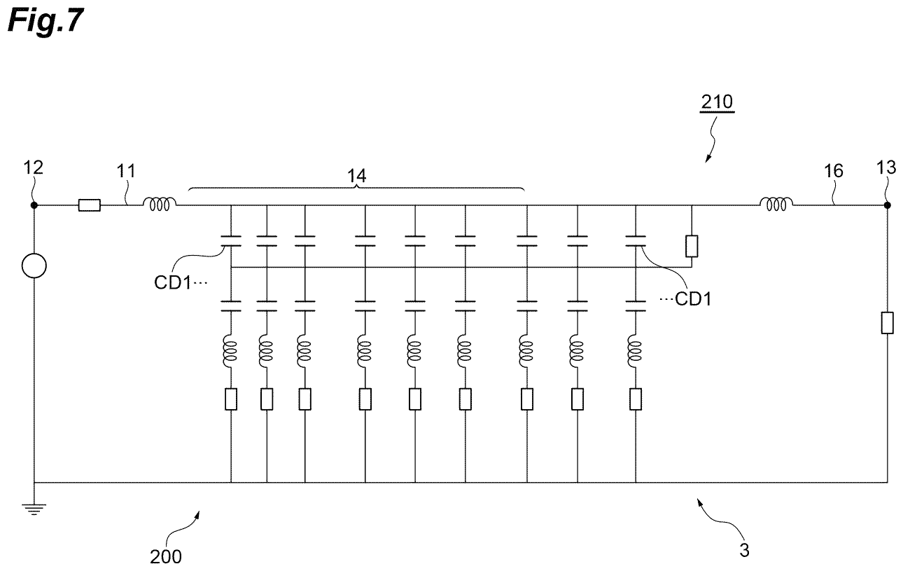

Here, a bus bar 210 according to a comparative example will be described with reference to FIG. 6. The bus bar 210 according to the comparative example is mainly different from the bus bar 10 according to the present embodiment in terms of not including the second capacitor connection portion 17 and the second path portion 18. Therefore, a capacitor for releasing noise of the bus bar 210 is connected only to the first capacitor connection portion 14 in a power supply device 200 according to the comparative example as illustrated in FIG. 7. Therefore, in a case where noise is added to an output current in the first path portion 16, the noise is output without being canceled. Note that the first capacitor connection portion 14 cannot be brought close to the output terminal 50 for structural reasons around the output terminal 50. In addition, in a case where the bus bar, a ferrite core, and the capacitor are integrally molded and configured as one noise canceling component, for example, an additional process such as assembly of a component for integral molding or resin molding is required.

On the other hand, the bus bar 10 according to the present embodiment includes the second capacitor connection portion 17 connected to the second capacitors CD2 mounted on the substrate 3, and the second path portion 18 electrically connecting the output terminal connection portion 13 and the second capacitor connection portion 17. Such a second path portion 18 branches off from the first path portion 16. Therefore, even in a case where the output current picks up noise between the first capacitor connection portion 14 and the output terminal connection portion 13, the noise can be released to the substrate 3 side by the second capacitor connection portion 17 via the second path portion 18 branching off from the first path portion 16. The bus bar 10 does not require a process such as integral molding or resin molding, and a noise filter having a high noise canceling effect can be configured only by a method of connecting a structure of the bus bar 10 and a capacitor surface-mounted on the substrate 3, and the power supply device 1 that hardly generates noise can be obtained. As described above, it is possible to reduce noise while suppressing cost and man-hours.

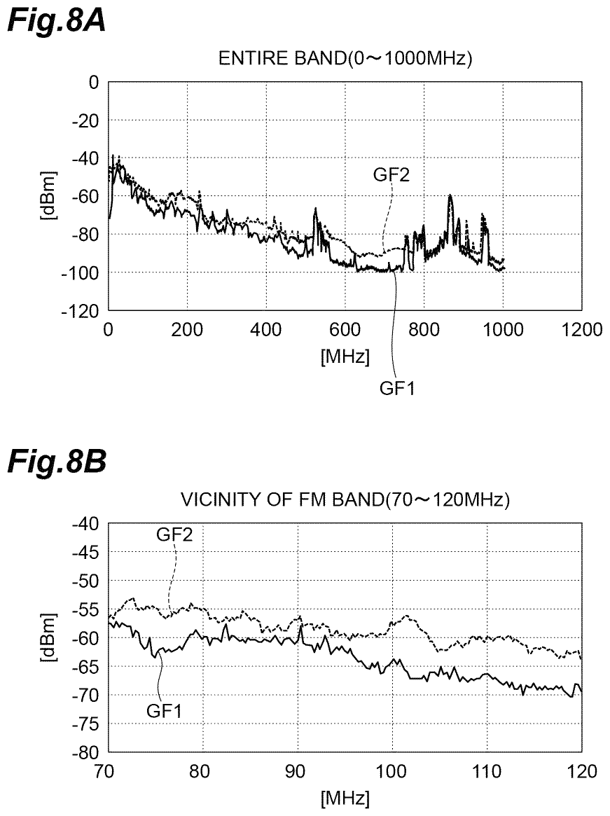

FIGS. 8A and 8B illustrate comparison results of noise reduced when the bus bar 10 of the embodiment and the bus bar 210 of the comparative example are used. FIG. 8A illustrates a measurement result of a transmission noise in the entire band, and FIG. 8B illustrates a measurement result in the vicinity of the FM band. As illustrated in FIG. 8B, noise can be reduced by using the bus bar 10 of the embodiment at any frequency at least in the FM band.

The second path portion 18 may branch off from the first path portion 16 at the output terminal connection portion 13. In this case, it is possible to suppress noise from being added to an output current between the branch portion (here, the output terminal connection portion 13) of the first path portion 16 and the second path portion 18, and the output terminal connection portion 13.

The second path portion 18 may be provided at a position closer to the output terminal connection portion 13 than the first path portion 16. In this case, it is possible to suppress noise from being applied to the output current in the second path portion 18.

Each of the first path portion 16 and the second path portion 18 may include a portion facing the side surface 2b of the housing. With this arrangement, the noise in the output current can be reduced due to the influence of the side surface 2b of the housing.

The power supply device 1 according to the present embodiment may include the above-described bus bar 10. As a result, it is possible to release noise generated from the power supply device 1 and reduce noise by using the above-described bus bar 10 in the power supply device 1.

The number of the second capacitors CD2 connected to the second capacitor connection portion 17 may be smaller than the number of the first capacitors CD1 connected to the first capacitor connection portion 14. As a result, a frequency band of noise that can be canceled by the first capacitor connection portion 14 and the second capacitor connection portion 17 increases, and the noise can be more effectively canceled.

The present disclosure is not limited to the above-described embodiment.

The size, arrangement, and quantity of each component are not limited to those of the above-described embodiment, and can be appropriately changed. In addition, the second path portion 18 branches off from the output terminal connection portion 13 in the above-described embodiment, but the position of branching from the first path portion 16 is not particularly limited. For example, the second path portion 18 may branch from any position of the first path portion 16 between the output terminal connection portion 13 and the first capacitor connection portion 14. In addition, the overall shape of the bus bar 10 is not limited to that illustrated in FIG. 2, and may be appropriately changed.

### Aspect 1

A bus bar configured to electrically connect a substrate housed in a housing and an output terminal, the bus bar including:
a main body portion extending in a predetermined direction;
a substrate connection portion connected to the substrate on one end side of the main body portion;
an output terminal connection portion connected to the output terminal on another end side of the main body portion;
a first capacitor connection portion connected to a first capacitor mounted on the substrate;
a first path portion configured to electrically connect the output terminal connection portion and the first capacitor connection portion, the first path portion including a part of the main body portion;
a second capacitor connection portion connected to a second capacitor mounted on the substrate; and
a second path portion configured to electrically connect the output terminal connection portion and the second capacitor connection portion,
wherein the second path portion branches off from the first path portion.

### Aspect 2

The bus bar according to Aspect 1, wherein the second path portion branches off from the first path portion at the output terminal connection portion.

### Aspect 3

The bus bar according to Aspect 1 or 2, wherein the second path portion is provided at a position closer to the output terminal connection portion than the first path portion.

### Aspect 4

The bus bar according to any one of Aspects 1 to 3, wherein each of the first path portion and the second path portion includes a portion facing a side surface of the housing.

### Aspect 5

A power supply device including the bus bar according to any one of Aspects 1 to 4.

### Aspect 6

The power supply device according to Aspect 5, wherein the number of the second capacitors connected to the second capacitor connection portion is smaller than the number of the first capacitors connected to the first capacitor connection portion.

### REFERENCE SIGNS LIST

2 Base plate (Housing)
3 Substrate
10 Bus bar
11 Main body portion
12 Substrate connection portion
13 Output terminal connection portion
14 First capacitor connection portion
16 First path portion
17 Second capacitor connection portion
18 Second path portion
100 Power supply device

What is claimed is:

1. A bus bar configured to electrically connect a substrate housed in a housing and an output terminal, the bus bar comprising:
a main body portion extending in a predetermined direction;
a substrate connection portion connected to the substrate on one end side of the main body portion;
an output terminal connection portion connected to the output terminal on another end side of the main body portion;
a first capacitor connection portion connected to a first capacitor mounted on the substrate;
a first path portion configured to electrically connect the output terminal connection portion and the first capacitor connection portion, the first path portion including a part of the main body portion;
a second capacitor connection portion connected to a second capacitor mounted on the substrate; and
a second path portion configured to electrically connect the output terminal connection portion and the second capacitor connection portion,
wherein the second path portion branches off from the first path portion.

2. The bus bar according to claim 1, wherein the second path portion branches off from the first path portion at the output terminal connection portion.

3. The bus bar according to claim 1, wherein the second path portion is provided at a position closer to the output terminal connection portion than the first path portion.

4. The bus bar according to claim 1, wherein each of the first path portion and the second path portion includes a portion facing a side surface of the housing.

5. A power supply device comprising the bus bar according to claim 1.

6. The power supply device according to claim 5, wherein a number of the second capacitors connected to the second capacitor connection portion is smaller than a number of the first capacitors connected to the first capacitor connection portion.
